(19) United States
(12) Patent Application Publication
(10) Pub. No.: US 2011/0196736 A1
(43) Pub. Date: Aug. 11, 2011

(54) KEYWORD BID OPTIMIZATION UNDER COST PER CLICK CONSTRAINTS

(75) Inventors: Phaniraju Srinivas Rao Pavagada, Bangalore (IN); Hastagiri Prakash, Chennai (IN); Ritesh Agarwal, Meerut (IN); Viswanathan Ramaiyer, Bangalore (IN)

(73) Assignee: Yahoo! Inc., Sunnyvale, CA (US)

(21) Appl. No.: 12/702,690

(22) Filed: Feb. 9, 2010

(51) Int. Cl. G06Q 30/00; G06Q 10/00

(52) U.S. Cl. 705/14.43; 705/14.71; 705/14.54

(57) ABSTRACT

The present invention provides methods and systems for determining optimized bidding on keywords in a sponsored search advertising keyword auction. Methods and systems are provided in which information is obtained including forecasting information and cost per click constraint information. The forecasting information includes forecasted cost versus clicks information and forecasted cost-per-click versus clicks information. Based at least in part on the forecasting information, an optimized set of keyword bids is determined, consistent with the one or more cost-per-click constraints, including iteratively determining an optimized keyword bid with a highest forecasted ratio of clicks to cost.

### BACKGROUND

Sponsored search advertising has grown dramatically in scale and profitability. Sponsored search advertising can involve an auction in which advertisers bid on particular keywords. The bids can specify, or be associated with, an amount the advertiser is willing pay for each user click on an advertisement presented in connection with a user query including, or relating to, a keyword or keywords. Bids can therefore be associated or correlated with cost to the advertiser.

In sponsored search advertising campaigns, determining a bidding strategy in connection with keywords dramatically affects profitability. However, determining an optimal bidding strategy, including particular bid amounts in connection with particular keywords, is a challenging task.

There is a need for methods and systems for determining optimized bidding in sponsored search advertising campaigns.

### SUMMARY OF THE INVENTION

Some embodiments of the present invention provide methods and systems for determining optimized bidding on keywords in a sponsored search advertising keyword auction. Methods and systems are provided in which information is obtained including forecasting information and cost per click constraint information. The forecasting information includes forecasted cost versus clicks information and forecasted cost-per-click versus clicks information. Based at least in part on the forecasting information, an optimized set of keyword bids is determined, consistent with the one or more cost-per-click constraints, including iteratively determining an optimized keyword bid with a highest forecasted ratio of clicks to cost.

In some embodiments, problems associated with gradient ascent type optimization methods are avoided. In graph analysis, gradient ascent methods may erroneously determine an optimal bid based on a local maximum slope. Some embodiments of the invention instead consider, at each iteration, points along an entire curve, for multiple curves associated with different keywords, thereby taking a more global approach and avoiding local maximum slope type problems. Furthermore, in some embodiments, graphs are updated after each iteration, to take into account the projected effect of a previous determined optimized bid. The updating can include transforming the origin of each graph to account for the previous determined optimized bid. Still further, some embodiments provide methods that can be effectively used in adhering to constraints including cost-per-per click constraints, such as a maximum cost-per-click.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 depicts two graphs, illustrating one embodiment of the invention.

While the invention is described with reference to the above drawings, the drawings are intended to be illustrative, and the invention contemplates other embodiments within the spirit of the invention.

### DETAILED DESCRIPTION

Some embodiments of the invention provide methods and systems for determining optimized bidding on keywords in a sponsored search advertising keyword auction. Methods and systems are provided in which information is obtained including forecasting information and cost per click constraint information. The forecasting information includes forecasted cost versus clicks information and forecasted cost-per-click versus clicks information. Based at least in part on the forecasting information, an optimized set of keyword bids is determined, consistent with the one or more cost-per-click constraints, including iteratively determining an optimized keyword bid with a highest forecasted ratio of clicks to cost.

The iterative determination can further include, for each of a number of successive intervals of the plurality of intervals, where each interval corresponds to certain incurred cost, taking into account projected bidding based at least in part on a previous optimized keyword bid, determining updated forecasting information, and, based at least in part on the updated forecasting information, determining an optimized keyword bid for the interval.

In some embodiments, obtaining the forecasting information includes obtaining, for each of a set of keywords, a set of graphs including forecasted cost versus clicks information and forecasted cost-per-click versus clicks information. Furthermore, in some embodiments, at each of a number of successive iterations, a determined optimized keyword bid from a previous iteration is accounted for by updating the graphs and shifting or transforming the origin of each graph in accordance with the previous determined optimized keyword bid.

In some embodiments, a cost per click constraint, which can be a maximum cost per click over a period, is accommodated by ensuring, at each iteration, that the maxi cost per click associated with the period, up to that iteration, is not exceeded. In some embodiments, for a given iteration, if a determined optimized keyword bid would cause the maximum cost per click to be exceeded, the determined optimized keyword bid and the corresponding incurred cost is not utilized, and another optimized bid is determined. This process may continue until an optimized keyword bid is determined that does not cause the maximum cost per click to be exceeded.

Some embodiments of the invention have great advantages over gradient ascent type optimization methods and algorithms, in which, in a graph including a curve relating to cost per click versus clicks, an optimized bid amount may be determined based on tracking the curve until its slope fails to continue to increase. Such methods, however, may merely determine a local maximum slope, and may miss points or areas further along the curve with a much higher slope, thereby failing badly in determining an optimal bid. By considering points throughout each curve, some embodiments of the invention avoid this local maximum trap, and allow determination of a much more optimal bid set.

In some embodiments, cost versus clicks graphs are utilized in determining, or determining candidate, optimized keyword bids. However, the optimized keyword bids must also satisfy one or more cost-per-click constraints. In some embodiments, a projected number of clicks for a keyword is determined based on a determined optimized keyword bid. Following this, cost-per-click versus clicks graphs can be utilized to ensure that the one or more cost-per-click constraints are adhered to.

In some embodiments, techniques are used in which points are considered along graphs in discrete increments, such as cost increments in terms of dollars. Such increments may be chosen so as to, among other things, provide a balance between providing sufficient accuracy, precision and granularity while yet not requiring too much time and computational magnitude and expense.

It is to be understood that more complex embodiments are contemplated than those described in detail herein. For example, generally, embodiments are described in connection with a single keyword bid being considered at each iteration or interval. Furthermore, embodiments are contemplated with more complex forecasting information and graphs, correspondingly more complex analysis and determination, etc.

Herein, the term “keyword” is intended to broadly include not just individual words, but also groups of words or characters or combinations thereof, terms, phrases, sets of words, terms, or phrases, etc. The term is also intended to include all words, terms, or phrases that fall into a specified group for bidding purposes, such as all search terms with the word “restaurant” in them, etc. Of course, many other possibilities exist and are contemplated.

It is noted that sponsored search advertising includes many known details and complex aspects that are not described herein. It is to be understood that embodiments of the invention are contemplated that include, consider, or incorporate such aspects.

Although embodiments of the invention are described with regard to sponsored search, and with regard to performance aspects such as clicks, cost-per-click, and click through rates, embodiments are contemplated that more broadly encompass other types of advertising, as well as other advertising contexts and measures. Furthermore, embodiments are contemplated in which certain aspects or measures are included in different or more complex ways. For example, selection methods other than clicks are contemplated. Furthermore, performance measures other than cost-per-click and click through rate are considered, such as CPM, conversion rate, etc. Still further, forecasting information according to embodiments of the invention, and analyses and determinations, can include such other or broader aspects or metrics.

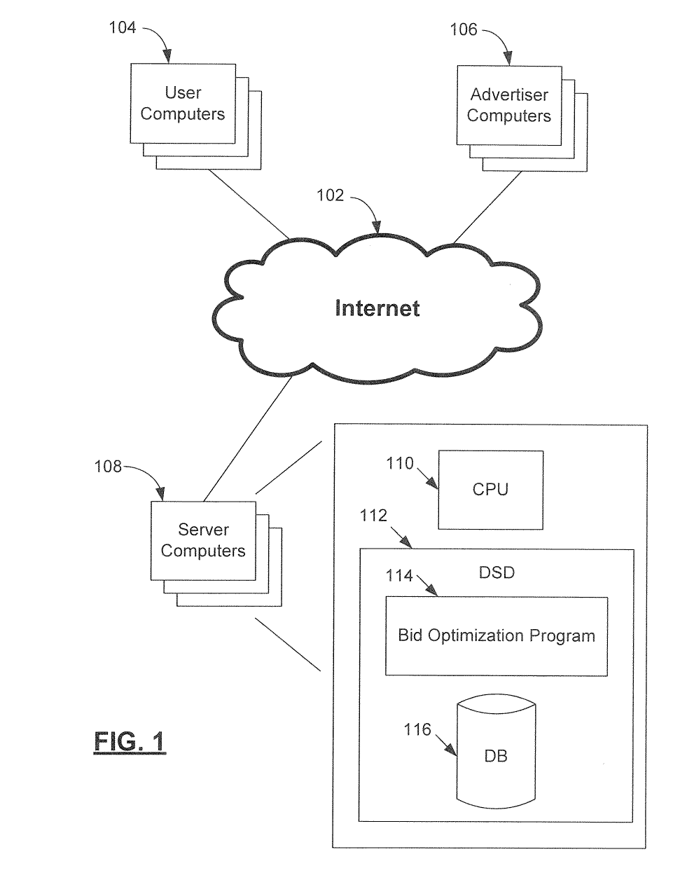

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Bid Optimization Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

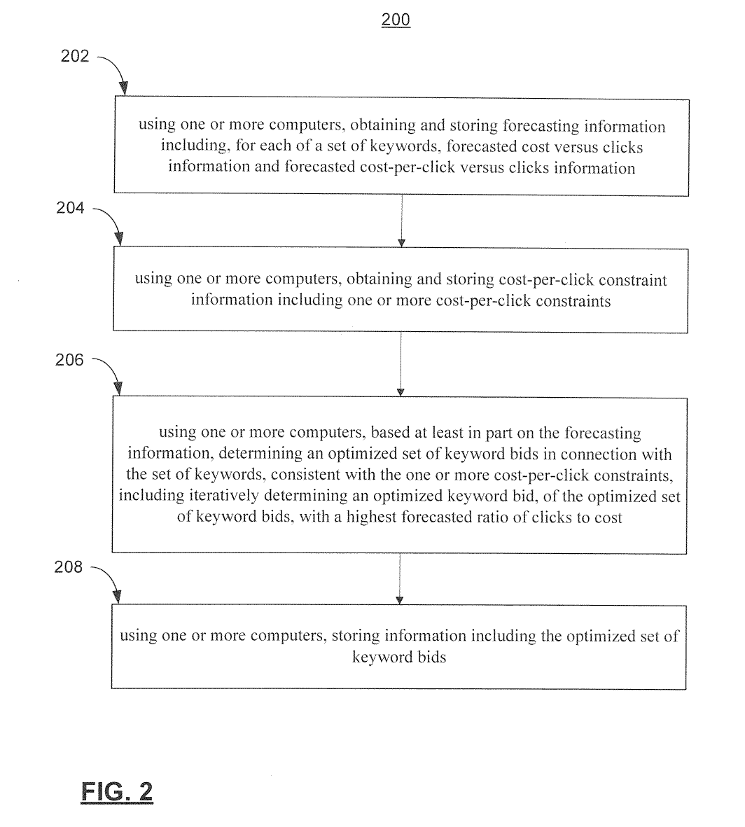

FIG. 2 is a flow diagram illustrating a method 200 according to one embodiment of the invention. At step 202, using one or more computers, forecasting information is obtained and stored, including, for each of a set of keywords, forecasted cost versus clicks information and forecasted cost-per-click versus clicks information.

At step 204, using one or more computers, cost-per-click constraint information is obtained and stored, including one or more cost-per-click constraints.

At step 206, using one or more computers, based at least in part on the forecasting information, an optimized set of keyword bids is determined in connection with the set of keywords, consistent with the one or more cost-per-click constraints, including iteratively determining an optimized keyword bid, of the optimized set of keyword bids, with a highest forecasted ratio of clicks to cost.

At step 208, using one or more computers, information is stored including the optimized set of keyword bids.

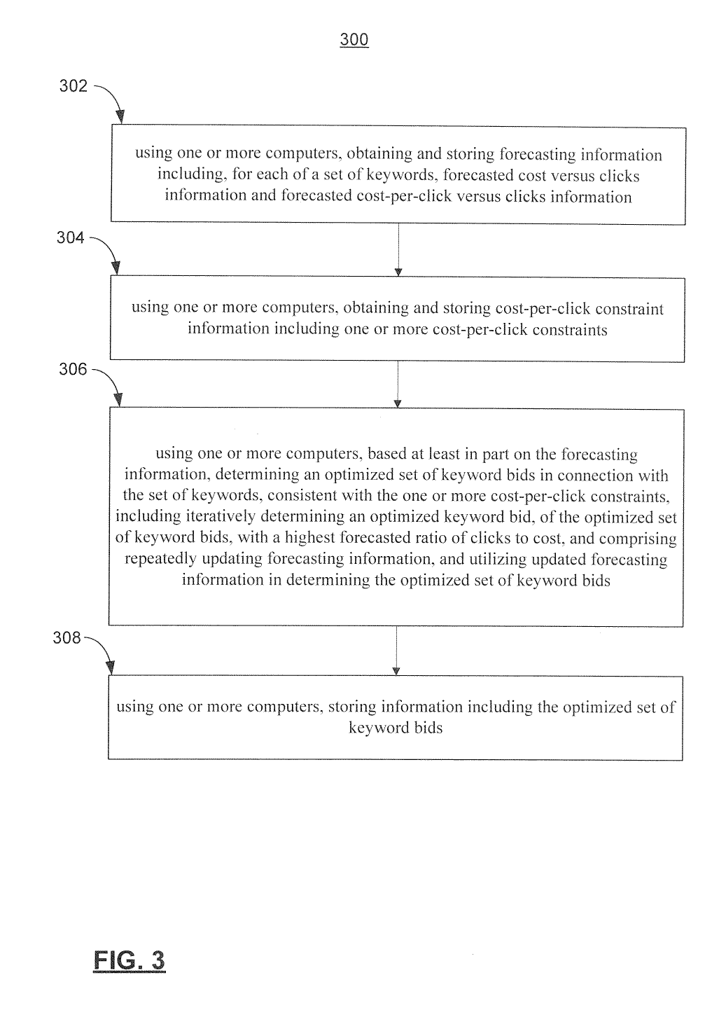

FIG. 3 is a flow diagram illustrating a method 300 according to one embodiment of the invention. Steps 302 and 304 are similar to steps 202 and 204 as depicted in FIG. 2.

At step 306, using one or more computers, based at least in part on the forecasting information, an optimized set of keyword bids is determined in connection with the set of keywords, consistent with the one or more cost-per-click constraints, including iteratively determining an optimized keyword bid, of the optimized set of keyword bids, with a highest forecasted ratio of clicks to cost. The iterative determination includes comprising repeatedly updating forecasting information, and utilizing updated forecasting information in determining the optimized set of keyword bids.

At step 308, using one or more computers, information is stored including the optimized set of keyword bids.

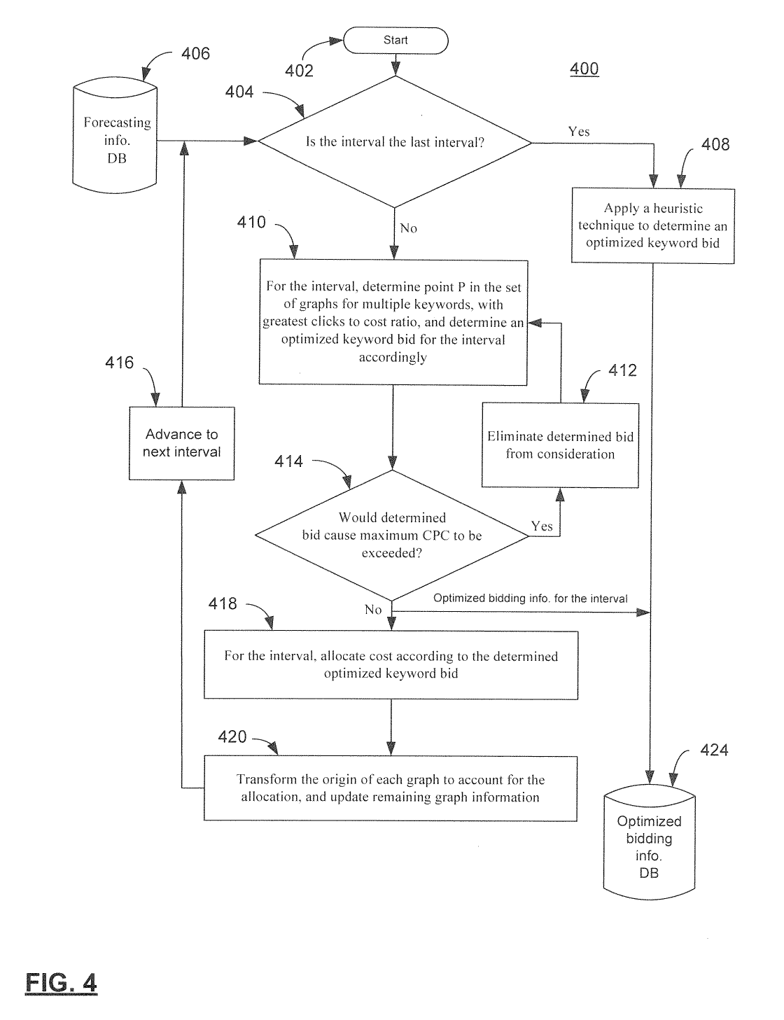

FIG. 4 is a flow diagram illustrating a method 400 according to one embodiment of the invention. Specifically, FIG. 4 depicts an iterative method or algorithm for determining an optimized set of keyword bids for a period including multiple intervals. In some embodiments, an interval may be associated with the size of a time period during which a bid cannot be changed. Block 402 indicates the start. At step 404, the method 400 queries whether the interval under consideration is the last interval of the period. Input information to the method 400 includes forecasting information from a forecasting information database 406.

If the interval is the last interval, then the usual iterative bid optimization steps are circumvented, and, at step 408, any known heuristic technique is utilized to determine optimized bidding for the interval. The determined optimized bidding for the interval is then stored in an optimized bidding information database 424.

If the interval is not the as interval, then the method 400 proceeds to step 410. At step 410, for the interval, a point P (or interval or set of points, etc.) is determined in the set of graphs for multiple keywords, with greatest clicks to cost ratio, and an optimized keyword bid is determined for the interval accordingly.

At step 414, the method 400 queries whether the determined optimized keyword bid would cause a maximum cost-per-click to be exceeded, for the portion of the period considered up to and including that interval. The maximum cost-per-click is one of many possible types of cost-per-click constraints. If it would, then the method 400 proceeds to step 412, at which the determined optimized keyword bid is eliminated from consideration. The method 400 then proceeds to step 410, at which a different optimized keyword hid is determined.

If at step 414, the determined optimized keyword bid would not cause the maximum cost per click to be exceeded, then determined optimized keyword bid information, relating to the determined optimized keyword bid, is stored in the optimized bidding information database 424. The method 400 then proceeds to step 418.

At step 418, for the interval, cost is allocated according to the determined optimized keyword hid. Step 418 can also include other types of allocations, including affects on inventory, etc.

At step 420, the origin of each graph is transformed to account for the allocation, and remaining graph information is updated.

The method 400 then proceeds to step 416, at which the method 400 advances to the next interval in the period.

The method 400 then returns to step 404, with regard to the next interval.

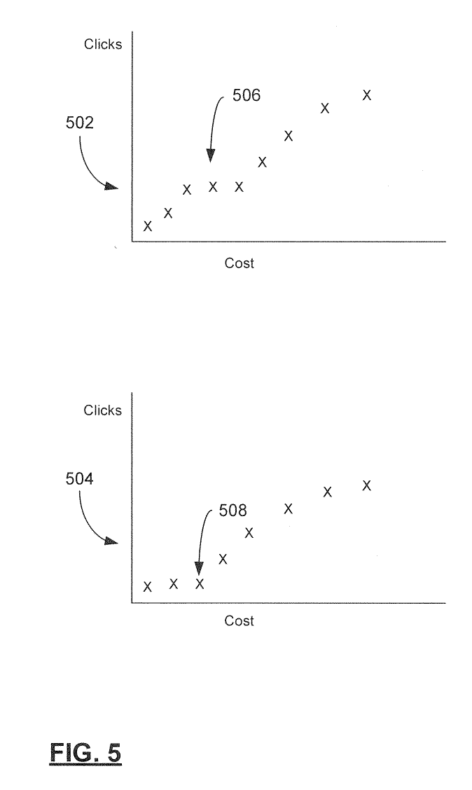

FIG. 5 depicts two graphs 502, 504, illustrating one embodiment of the invention.

Graph 502 depicts a simplified example of forecasted cost versus clicks for a keyword over a period. The graph could be one of many graphs for many keywords under consideration.

According to some embodiments of the invention, at each iteration, a cost versus click graph is analyzed for each keyword under consideration. Furthermore, methods according to some embodiments of the invention consider points along the entirety of each graph, thereby avoiding local maxima problems.

As depicted, graph 502 includes a portion 506 at which the slope of the curve drops off, but then eventually picks up again. Gradient ascent type methods might move along the curve from left to right, encounter the slope drop off, and determine an optimal point or interval without ever getting to the portion of the curve on the right following the drop off, where the slope again picks up. This, in turn, can lead to selection of an optimized keyword bid which may in fact be very far from optimal. Methods according to some embodiments of the invention are able to look past such local drop offs, considering all portions of the curve, including portions beyond drop offs. Additionally, at each iteration, each of many graphs are considered, each corresponding to a different keyword, leading to optimized selection both of the keyword to bid on and on the optimized bid for the keyword for the appropriate iteration.

Graph 504 reflects the result of moving or transforming the origin after an iteration. In the depicted iteration, the initial part of the graph 504, up to the third depicted point 508, has been marked as having been allocated. As a result, the origin is moved or transformed to the third point 508, leading to the modified graph, graph 504.

The foregoing description is intended merely to be illustrative, and other embodiments are contemplated within the spirit of the invention.

1. A method for use in determining optimized bidding on keywords in a sponsored search advertising keyword auction, the method comprising:
using one or more computers, obtaining and storing forecasting information comprising, for each of a set of keywords, forecasted cost versus clicks information and forecasted cost-per-click versus clicks information;
using one or more computers, obtaining and storing cost-per-click constraint information comprising one or more cost-per-click constraints;
using one or more computers, based a least in part on the forecasting information, determining an optimized set of keyword bids in connection with the set of keywords, consistent with the one or more cost-per-click constraints, comprising iteratively determining an optimized keyword bid, of the optimized set of keyword bids, with a highest forecasted ratio of clicks to cost; and
using one or more computers, storing information comprising the optimized set of keyword bids.

2. The method of claim 1, comprising repeatedly updating forecasting information, and utilizing updated forecasting information in determining the optimized set of keyword bids.

3. The method of claim 2, comprising:
obtaining budget information comprising a maximum spend over the applicable period; and
determining the optimized set of keyword bids consistent with the max u spend.

4. The method of claim 3, wherein obtaining the forecasting information comprises obtaining, for each keyword of the set of keywords, at least one graph including forecasted cost versus clicks information and forecasted cost-per-click versus clicks information, and wherein determining updated forecasting information comprises determining updated graphs.

5. The method of claim 4, comprising, at each of a plurality of iterations, transforming an origin of each of the updated graphs based at least in part on a keyword bid associated with a previous one or more iterations.

6. The method of claim 5, comprising, at each of the plurality of iterations, determining a point in one of the updated graphs that has the highest clicks to cost ratio, and comprising determining an optimized keyword bid including a keyword and a bid.

7. The method of claim 6, wherein updating the forecasting information comprises updating forecasting information for each of the keywords, and wherein determining a point in one of the updated graphs that has the highest clicks to cost ratio comprises taking into account a graph relating to each of the keywords.

8. The method of claim 7, wherein determining an optimized set of keyword bids comprises determining a set of keyword bids in association with particular ones of the keywords.

9. The method of claim 8, comprising, at each of a plurality of iterations, based at least in part on forecasting information, ensuring that the one or more cost-per-click constraints are not violated.

10. The method of claim 9, wherein ensuring that the one or more cost-per-click constraints are not violated comprises determining, for a particular keyword bid at a particular iteration, whether a determined keyword bid would cause any of the one or more cost-per-click constraints to be exceeded, and, if so, determining, as an optimized keyword bid for the particular iteration, a different keyword bid that would not cause any of the one or more cost-per-click constraints to be exceeded.

11. The method of claim 10, comprising, on a final iteration, utilizing a heuristic approach to determine an optimized keyword bid.

12. The method of claim 11, wherein the method utilizes a global approach to graph analysis and point selection which considers all portions of graphs.

13. The method of claim 1, comprising implementing bidding during an auction based at least in part on the optimized set of keyword bids.

14. A system for use in determining optimized bidding on keywords in a sponsored search advertising keyword auction, comprising:
one or more server computers coupled to a network; and
one or more databases coupled to the one or more server computers;
wherein the one or more server computers are for:
obtaining and storing, in a least one of the one or more databases, forecasting information comprising, for each of a set of keywords, forecasted cost versus clicks information and forecasted cost-per-click versus clicks information;
obtaining and storing, in at least one of the one or more databases, cost-per-click constraint information comprising one or more cost-per-click constraints;
based at least in part on the forecasting information, determining an optimized set of keyword bids in connection with the set of keywords, consistent with the one or more cost-per-click constraints, comprising iteratively determining an optimized keyword bid, of the optimized set of keyword bids, with a highest forecasted ratio of clicks to cost; and
storing, in at least one of the one or more databases, information comprising the optimized set of keyword bids.

15. The system of claim 14, wherein the network comprises the Internet.

16. The system of claim 14, comprising implementing bidding based at least in part on the optimized set of keyword bids.

17. The system of claim 14, comprising repeatedly updating forecasting information, and utilizing updated forecasting information in determining the optimized set of keyword bids.

18. The system of claim 17, comprising:
obtaining budget information comprising a maximum spend over the applicable period; and
determining the optimized set of keyword bids consistent with the maximum spend.

19. A computer readable medium or media containing instructions for executing a method relating to advertising in connection with video, the method comprising:
using one or more computers, obtaining and storing forecasting information comprising, for each of a set of keywords, forecasted cost versus clicks information and forecasted cost-per-click versus clicks information;
using one or more computers, obtaining and storing cost-per-click constraint information comprising one or more cost-per-click constraints;
using one or more computers, based at least in part on the forecasting information, determining an optimized set of keyword bids in connection with the set of keywords, consistent with the one or more cost-per-click constraints, comprising iteratively determining an optimized keyword bid, of the optimized set of keyword bids, with a highest forecasted ratio of clicks to cost, and comprising repeatedly updating forecasting information, and utilizing updated forecasting information in determining the optimized set of keyword bids; and
using one or more computers, storing information comprising the optimized set of keyword bids.

20. The computer readable medium of claim 19, wherein the method further comprises implementing bidding based at least in part on the optimized set of keyword bids.
